(19) United States
(12) Patent Application Publication
(10) Pub. No.: US 2002/0178124 A1
(43) Pub. Date: Nov. 28, 2002

(54) Credit card verification system

(76) Inventor: Shawn Michael Lewis, Akron, OH (US)

Correspondence Address: Alfred F. Hoyte, Esq., Suite 711, 733 15th Street N.W., Washington, DC, 20012, US

(21) Appl. No.: 09/861,643

(22) Filed: May 22, 2001

(51) Int. Cl. G06F 17/60

(52) U.S. Cl. 705/67; 705/44

(57) ABSTRACT

These and other objects of the invention are accomplished by providing a fingerprint identification credit/debit card system where a bitmap generated from a scan of the user's finger, in combination with a user selected and changeable PIN, is the only data associated with the card. The bitmap, or an electronic representation thereof, is stored on the credit/debit card, as well as in the card issuer computer system. The PIN is stored only on the card issuer computer system. When the user presents the card to a merchant or service provider, the bitmap stored on the card is input using an appropriate input device which may be a magnetic card reader, a scanner, or a device capable of receiving data from an electronic chip, and transmitted to the card issuer computer system for verification and authorization. The user manually inputs the PIN using an associated keypad. If the comparison of the bitmap and PIN presented by the user generates a match with that stored in the card issuer computer, then the user presenting the card is given authorization to use the card for a transaction.

### BACKGROUND OF THE INVENTION

The present invention relates to secure electronic transaction systems. More particularly, it relates to a credit card with a human fingerprint electronically stored thereon, and a transaction system for use with the card.

### STATEMENT OF THE PRIOR ART

Cards having magnetic stripes are widely used in secure electronic transaction systems for identifying a particular individual. For example, in a card to be used for a deposit or withdrawing apparatus installed in a bank such as an ATM (hereinafter referred to as “ATM card”) there is stored a code for recognizing the genuineness of the card and a password code for judging whether a card possessor is the registered user of the card or not. Accordingly, the deposit apparatus is designed to read out the genuineness code in the card to judge whether the card is genuine or not, to instruct the card possessor to input a password code from the keyboard, and to judge whether the card possessor is an authorized card possessor or not based upon the result of comparison of the input password code with the password code registered in the card. In this system, a numeral or symbol sequence which is relatively easy to memorize is appropriate for use as a password code. While this system is generally satisfactory as evidenced by its continued use, it does suffer from drawbacks, especially in light of the extreme proliferation of password based electronic secure transaction systems.

The first drawback is that the user will tend to use a simple password, related to his or her initials or birthday. While the password is easy to remember, a sophisticated thief may be able to figure out the password. A more complicated number such as a 10 digit account number offers more security but is extremely difficult to remember for most people. In order to deal with this problem, credit/debit card issuers have begun experimenting with “bio-identifiers” or biometric identification such as finger print and retinal scan data which is specific to a particular individual.

There have been many biometric identification systems proposed for verifying identity by analyzing a non-variant physical characteristic of a person, such as a fingerprint. Some of these systems utilize an examination of the image of the fingerprint by irradiating the fingerprint with light. The image formation can be filtered in terms of frequencies and compared with similar stored information.

In other systems, a light diffraction pattern is generated from a person's fingerprint and an electrical function of the detected diffraction pattern is derived. The technique for deriving the electrical function of the diffraction pattern involves a mechanical scanning of the diffraction pattern so that electrical information is derived in series; that is, the electrical function is continuously generated over a period of time corresponding to the time necessary to complete the scanning of the pattern. This electrical function can be compared with a stored electrical function to determine if a proper correlation exists, thereby verifying the identity of a person. Although fingerprint based identification systems have proven to be highly effective, they have not been able to fully utilize all of the potential parameters that can be scanned from a fingerprint. Until recently the technology has been available but simply not cost effective for the average commercial user.

The reliability and accuracy of any specific identification or verification system depends on the amount of information that can be derived for comparison with pre-registered stored information. As a result, the derived function from an image of a person's fingerprint is more reliable as more parameters are able to be stored and analyzed.

The U.S. Pat. No. 5,361,453 Gagne, et al discloses a non-minutae automatic fingerprint identification system and process for verifying a person's identity by utilizing fingerprint patterns for the verification. A person who desires to use this system allows their fingerprint to be video scanned, and subsequently digitized. Once digitized, the fingerprint is assigned a non-minutae numerical identifier. The digitized numerical identifier comprises bytes of fingerprint identification data, which is recordable within the magnetic strip of a credit, or other similar card. A fingerprint match must be established or access to the card will be declined. By contrast, the present invention contemplates a system where the fingerprint is permanently affixed to the card and is used in place of a card number and associated magnetic strip. No other data is imprinted on the card.

U.S. Pat. No. 5,869,822 issued to Meadows et al. discloses a fingerprint identification system where the card holder registers a fingerprint of their choice with the card issuer. A composite number generated by analyzing the fingerprint is encoded onto the card, the same number is stored in the card issuers database. In order to verify that a particular card holder is an authorized user, the purported card holder has his fingerprint scanned in, with the digitized image generated thereby sent to the card issuers database for comparison with the stored image. If there is a match, then the card holder is identified as the authorized user. By contrast, the present invention provides a fingerprint identification system where the fingerprint or a digitized representation thereof is stored on the card. The digitized representation may be stored on a “chip”, mag stripe or using other electronic memory means and represents the only identifying data associated with the card.

### SUMMARY OF THE INVENTION

Accordingly, it is a principal object of the invention to provide an improved fingerprint identification credit/debit card system.

Accordingly, it is an object of the invention to provide an improved fingerprint identification credit/debit card system where the card holder's fingerprint is not scanned to enable authorization.

It is another object of the invention to provide an improved fingerprint identification credit/debit card system where the fingerprint or a digital version thereof is used in lieu of a card number.

It is another object of the invention to provide an improved fingerprint identification credit/debit card system where a secondary photo identification card is required to obtain authorization to use the card.

It is another object of the invention to provide an improved fingerprint identification credit/debit card system where a PIN number is used in combination with encoded fingerprint information.

These and other objects of the invention are accomplished by providing a fingerprint identification credit/debit card system where a bitmap generated from a scan of the user's finger, in combination with a user selected and changeable PIN, is the only data associated with the card. The bitmap, or an electronic representation thereof, is stored on the credit/debit card, as well as in the card issuer computer system. The PIN is stored only on the card issuer computer system. When the user presents the card to a merchant or service provider, the bitmap stored on the card is input using an appropriate input device which may be a magnetic card reader, a scanner, or a device capable of receiving data from an electronic chip, and transmitted to the card issuer computer system for verification and authorization. The user manually inputs the PIN using an associated keypad. If the comparison of the bitmap and PIN presented by the user generates a match with that stored in the card issuer computer, then the user presenting the card is given authorization to use the card for a transaction.

Finally, it is a general object of the invention to provide improved elements and arrangements thereof in an apparatus for the purposes described which is fully effective in accomplishing its intended purpose.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1. shows a block diagram of a fingerprint identification system for credit/debit cards in accordance with the present invention.

FIG. 2. shows a block diagram of the card encoding system of the present invention.

### DETAILED DESCRIPTION

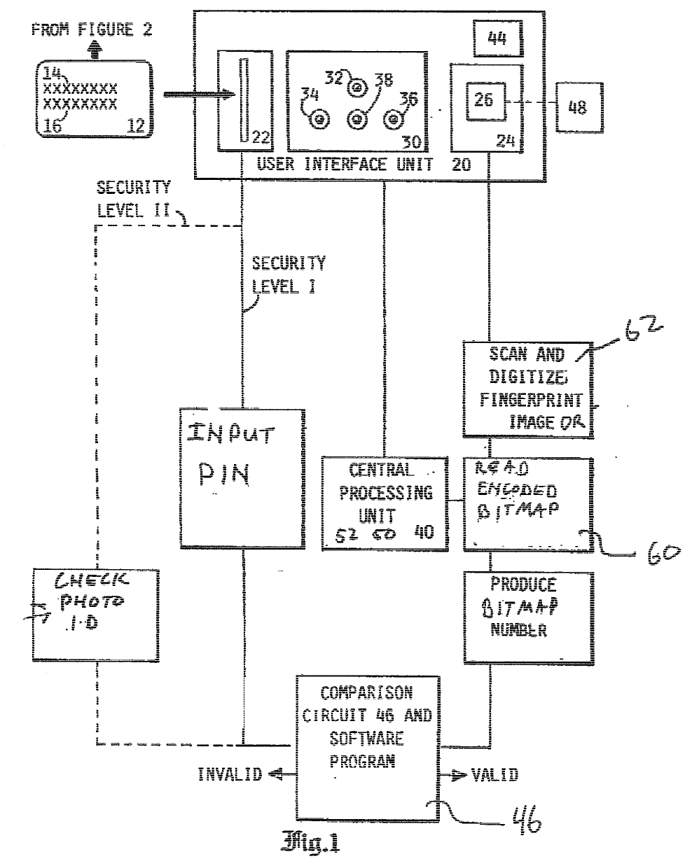

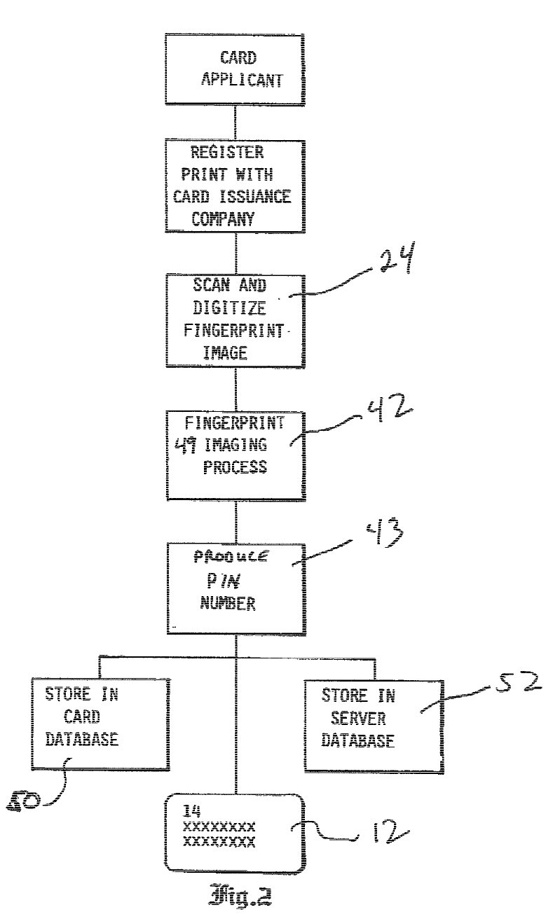

Referring now to FIGS. 1 and 2, the credit/debit card system of the present invention will now be described. The best mode for carrying out the automated fingerprint identification system is presented in terms of a preferred embodiment as shown in FIGS. 1-2. The system 10 is basically comprised of an encoded card, such as a credit card 12 and a user interface unit 20. The unit 20 functions in combination with a fingerprint imaging process 22 to produce a bitmap image 14 which is compared with a previously registered bitmap image 14. If the two bitmap images are similar a card transaction is allowed if the two bitmap images are not similar the transaction is disallowed. The system 10 is depicted in the blockflow diagram of FIG. 1.

The credit card 12 is encoded with the bitmap image 14 that comprises the fingerprint belonging to the credit card owner. The card 12 may also include a personal identification number (PIN) 43. The encoded bitmap image 14 is derived from the fingerprint imaging process 42. The fingerprint imaging process 42 is operated by a fingerprint imaging software program 49.

The process for producing and using a card 12 having imprinted thereon the bitmap image 14 is as follows. Initially as shown in FIG. 2, a card applicant submits his or her fingerprint to a card issuance company i.e., a bank, for registration. At the company, the fingerprint is scanned by a fingerprint scanner 24, the scanned fingerprint image is digitized, by means of the fingerprint imaging process 42, and a bitmap image 14 produced. The user selects a PIN 43 which is easy to remember. A digital representation of the bitmap image 14 is encoded on the newly issued card and the digital representation of the bitmap image, along with the user selected PIN are also stored in a card database 50 or a server database 52. The bitmap image 14 may be stored on the card 12 either in digitized form on e.g., a magnetic strip, a microprocessor embedded in the card 12, or other electronic means. Alternatively, the bitmap image 14 is printed on the card 12, preferably at least twice the size of the user's fingerprint. Any suitable technique may be used for the printing process provided high resolution is obtainable. In accordance with one aspect of the invention, a minimum resolution of 2400×1200 is required to ensure sufficient definition to uniquely identify the fingerprint during the scanning process. Of course, the scanner 24 must have a comparably high resolution. To use the issued encoded card 12, it is presented to a merchant or the like, where the card and applicant are subjected to a two-part verification process as shown in FIG. 1: In the first part, the issued card 12, is processed by the card reader 22 and subsequently applied to the card database 50 or server data base 52. In the event of an electronically stored bitmap image 14, the image 14 is applied to the card database or server database without further processing 60; if the bitmap image 14 is printed, a digitized bitmap image is generated 62 by the card reader 22 and then applied to the card database 50 or server data base 52. Alternatively, a numeric representation of the bitmap image is produced using an algorithm as would be apparent to one of skill in the art. The algorithm could, for instance, assign a value to each pixel in the image depending on whether the pixel is black or white. The bitmap image 14 is then applied to the comparison circuit 46 as shown in FIG. 1. In the second and third parts of the verification process, the card owner submits his or her PIN number 43 via keypad 26, and submits photo identification to the merchant for comparison. The PIN is compared to the PIN stored for the particular user and the photo identification is visually inspected by the owner to ascertain that the name, description, and image of the user presenting the card matches that on the photo identification. Thus, if the card is stolen, the thief must pass visual examination. Also, as there is no credit card number, there is no way a thief could use the card over the Internet or telephone.

The bitmap image 14, derived from the merchant location, is applied to the comparison circuit 46. If the bitmap image 14 from the merchant scanner 24, or the bitmap image 14 transmitted from the merchant in digitized form of the bitmap image 14 is similar to the bitmap image 14 stored on card database 50 or server data base 52, the card 12 is validated and the transaction allowed pending results of the comparison of the PIN and validation of the photo identification; conversely, if the two bitmap images 14 are not similar, or the PIN and/or photo identification of the card 12 is invalidated, the transaction is disallowed.

The fingerprint may be selected from any finger of either hand and is preferably physically scanned and encoded at the card issuance company. However, in some cases, the fingerprint may consist of a verified copy of the fingerprint as can be obtained from a government agency such as the Department of Motor Vehicles (DMV). In either case, the fingerprint is processed, encoded and ultimately imprinted on the credit card 12 as the bitmap image 14 that represents the fingerprint of the specific credit card applicant. The credit card 12 may also be encoded with a plurality of bitmap images 14 which correspond to a plurality of fingerprints. For example, a couple, such as a husband and wife, may elect to have both their bitmap images 14 on a single credit card 12 to allow either party to use the same card 12. It can be appreciated that the use of a bitmap, in lieu of the actual fingerprint, reduces the possibility of an in accurate scan due to sweaty hands, or occlusion of the scanning window with smudges or debris.

The user interface unit 20, as shown in a block form in FIG. 1, is typically comprised of the following major elements: a credit card reader 22, which may be a fingerprint scanner 24 for scanning the imprinted image on the card 12, that preferably operates in combination with a display panel 30, a central processing unit 40 that operates with a fingerprint imaging process 42 which can be in the form of firmware when the system 10 is self-contained or software, a comparison circuit 46 and a power supply 44. The credit card reader 22, fingerprint scanner 24, and the central processing unit 40, are readily available and conventionally connected.

The display panel 30, as shown in FIG. 1, incorporates a start button 32 that when pressed, allows the system 10 to commence operation, as shown in FIGS. 1 and 2, a PASS LED 34, a FAIL LED 36 that when lit indicates that the credit card is valid or invalid respectfully and a TRY AGAIN LED 38 that when lit indicates that the system 10 has obtained marginal results and therefore the card presenter is requested to try again.

The comparison circuit 46, which is an element of the user interface unit 20, compares the stored digital bitmap of the scanned fingerprint with the bitmap image 14 encoded in the credit card 12 and applied to the circuit 46 via the card database 50 or server data base 52 as shown in FIG. 1. The comparison circuit 46, is operated by a comparison circuit software program as is well known in the art. The comparison circuit includes circuit means for comparing the fingerprint parameters from both the person trying to gain access, and from the card database or server database, to each other. The comparison circuit awards points to the person passing for himself or herself depending on how similar or dissimilar the fingerprint parameters are. If the points totaled after comparing all the fingerprint parameters exceeds a pre-determined threshold, the card 12 is validated and a transaction is allowed. Higher thresholds allow for stricter security, as would be apparent to one skilled in the art.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

What is claimed is:

1. A credit/debit card identification method comprising the steps of:
scanning a cardholder fingerprint into a computer system to generate a bitmap image and storing the bitmap image in a digitized format, as well as a cardholder selected PIN, in a card database of said computer system, encoding said bitmap image on said card for subsequent verification,
presenting said encoded card to a merchant for processing by a card reader and verification by said card database or said server database wherein, said bitmap image on said encoded card is applied to a comparison circuit which is operated by a comparison circuit software program,
applying said bitmap image derived from the merchants card reader to said comparison circuit, if said bitmap image from said card reader is similar to said bitmap image stored on said card database or server database, the card is validated conversely, if the two bitmap images are not identical, the card is invalidated;
allowing a transaction based upon entry and comparison of a PIN to the stored cardholder selected PIN, as well as the merchant's visual inspection of a valid photo identification presented by the cardholder at the time of the transaction.
